(19) United States
(12) Patent Application Publication
(10) Pub. No.: US 2024/0326341 A1
(43) Pub. Date: Oct. 3, 2024

(54) THREE-DIMENSIONAL SHAPING DEVICE

(71) Applicant: SEIKO EPSON CORPORATION, Tokyo (JP)

(72) Inventors: Takafumi SAMESHIMA, SHIOJIRI-SHI (JP); Yuta SAKAI, SHIOJIRI-SHI (JP); Taki HASHIMOTO, SHIOJIRI-SHI (JP)

(21) Appl. No.: 18/617,038

(22) Filed: Mar. 26, 2024

(30) Foreign Application Priority Data
Mar. 28, 2023 (JP) 2023-051094

(51) Int. Cl. B29C 64/393; B29C 64/209; B29C 64/236; B29C 64/245; B29C 64/295; B33Y 30/00; B33Y 50/02

(52) U.S. Cl. CPC B29C 64/393; B29C 64/209; B29C 64/236; B29C 64/245; B29C 64/295; B33Y 30/00; B33Y 50/02

(57) ABSTRACT

A three-dimensional shaping device includes: a dispensing unit including a plasticizing unit that includes a first heater and plasticizes a material to generate a plasticizing material, and a nozzle that dispenses the plasticizing material; a stage on which the plasticizing material is stacked; a heating unit including a second heater that heats the plasticizing material stacked on the stage; a drive unit configured to change a relative position between the nozzle and the heating unit; and a control unit configured to control the drive unit. A tip end of the nozzle is positioned below the heating unit during shaping of a three-dimensional shaped object, and the control unit controls the drive unit to set a distance between the tip end of the nozzle and the heating unit based on at least one of a temperature of the dispensing unit, a temperature of the heating unit, and a distance between the stage and the tip end of the nozzle.

The present application is based on, and claims priority from JP Application Serial Number 2023-051094, filed Mar. 28, 2023, the disclosure of which is hereby incorporated by reference herein in its entirety.

### BACKGROUND

### 1. Technical Field

The present disclosure relates to a three-dimensional shaping device.

### 2. Related Art

There is known a three-dimensional shaping device that shapes a three-dimensional shaped object by dispensing a plasticized material toward a stage and curing the material.

For example, JP-A-2022-170965 describes a three-dimensional shaping device including a stage on which a shaping material is stacked, a nozzle that dispenses the shaping material toward a shaping region on the stage, and a heating unit that heats the shaping material stacked in the shaping region on the stage.

JP-A-2022-170965 is an example of the related art.

In the three-dimensional shaping device including the heating unit as described above, since a thermal expansion amount of the heating unit changes according to a temperature of the heating unit, a distance between the stage and the heating unit changes, which may affect shaping accuracy of the three-dimensional shaped object. Other than such a heating unit, there may be a factor that affects the shaping accuracy depending on the temperature.

### SUMMARY

A three-dimensional shaping device according to an aspect of the present disclosure includes:
a dispensing unit including a plasticizing unit that includes a first heater and plasticizes a material to generate a plasticizing material, and a nozzle that dispenses the plasticizing material;
a stage on which the plasticizing material is stacked;
a heating unit including a second heater that heats the plasticizing material stacked on the stage;
a drive unit configured to change a relative position between the nozzle and the heating unit; and
a control unit configured to control the drive unit, in which
a tip end of the nozzle is positioned below the heating unit during shaping of a three-dimensional shaped object, and
the control unit controls the drive unit to set a distance between the tip end of the nozzle and the heating unit based on at least one of a temperature of the dispensing unit, a temperature of the heating unit, and a distance between the stage and the tip end of the nozzle.

### BRIEF DESCRIPTION OF THE DRAWINGS

FIG. 1 is a perspective view schematically showing a three-dimensional shaping device according to an embodiment.

FIG. 2 is a cross-sectional view schematically showing the three-dimensional shaping device according to the embodiment.

FIG. 3 is a perspective view schematically showing a flat screw of the three-dimensional shaping device according to the embodiment.

FIG. 4 is a diagram schematically showing a barrel of the three-dimensional shaping device according to the embodiment.

FIG. 5 is a flowchart showing processing of a control unit of the three-dimensional shaping device according to the embodiment.

FIG. 6 is a cross-sectional view showing the processing of the control unit of the three-dimensional shaping device according to the embodiment.

FIG. 7 is a cross-sectional view showing the processing of the control unit of the three-dimensional shaping device according to the embodiment.

FIG. 8 is a cross-sectional view showing the processing of the control unit of the three-dimensional shaping device according to the embodiment.

FIG. 9 is a flowchart showing processing of a control unit of a three-dimensional shaping device according to a first modification of the embodiment.

FIG. 10 is a cross-sectional view showing the processing of the control unit of the three-dimensional shaping device according to the first modification of the embodiment.

FIG. 11 is a cross-sectional view showing the processing of the control unit of the three-dimensional shaping device according to the first modification of the embodiment.

FIG. 12 is a flowchart showing processing of a control unit of a three-dimensional shaping device according to a second modification of the embodiment.

FIG. 13 is a cross-sectional view showing the processing of the control unit of the three-dimensional shaping device according to the second modification of the embodiment.

FIG. 14 is a cross-sectional view showing the processing of the control unit of the three-dimensional shaping device according to the second modification of the embodiment.

FIG. 15 is a flowchart showing processing of a control unit of a three-dimensional shaping device according to a third modification of the embodiment.

FIG. 16 is a cross-sectional view showing the processing of the control unit of the three-dimensional shaping device according to the third modification of the embodiment.

FIG. 17 is a cross-sectional view showing the processing of the control unit of the three-dimensional shaping device according to the third modification of the embodiment.

### DESCRIPTION OF EMBODIMENTS

Hereinafter, preferred embodiments of the present disclosure will be described in detail with reference to the drawings. The embodiments to be described below do not unduly limit contents of the present disclosure described in the claims. In addition, not all configurations to be described below are necessarily essential components of the present disclosure.

### 1. Three-Dimensional Shaping Device

### 1.1. Overall Configuration

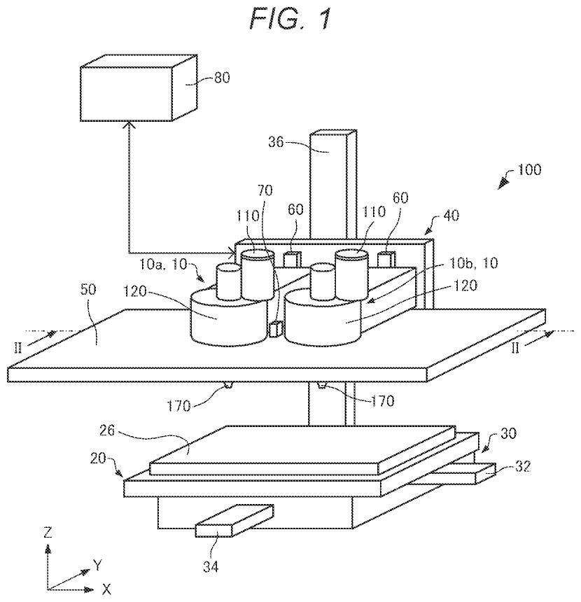

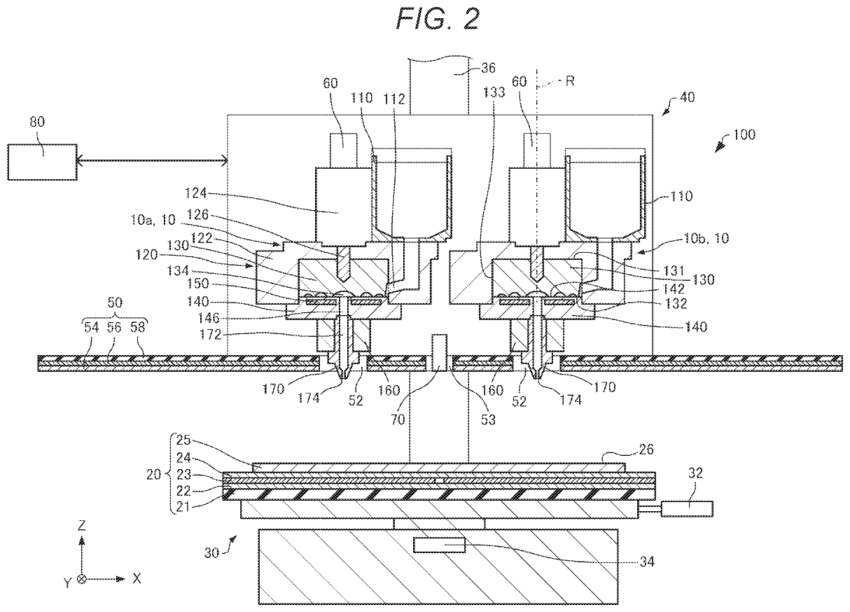

First, a three-dimensional shaping device according to the embodiment will be described with reference to the drawings. FIG. 1 is a perspective view schematically showing a three-dimensional shaping device 100 according to the embodiment. FIG. 2 is a cross-sectional view taken along a line II-II of FIG. 1 schematically showing the three-dimensional shaping device 100 according to the embodiment. In FIGS. 1 and 2, an X-axis, a Y-axis, and a Z-axis are shown as three axes orthogonal to one another. An X-axis direction and a Y-axis direction are, for example, horizontal directions. A Z-axis direction is, for example, a vertical direction.

As shown in FIGS. 1 and 2, the three-dimensional shaping device 100 includes, for example, dispensing units 10, a stage 20, a position changing unit 30, a support unit 40, a heating unit 50, a drive unit 60, a temperature sensor 70, and a control unit 80.

The three-dimensional shaping device 100 changes relative positions of the dispensing unit 10 and the stage 20 by driving the position changing unit 30 while dispensing a plasticizing material plasticized from the dispensing unit 10 toward the stage 20. Accordingly, the three-dimensional shaping device 100 shapes a three-dimensional shaped object having a desired shape on the stage 20. The three-dimensional shaping device 100 is a three-dimensional shaping device of fused deposition modeling (FDM) (registered trademark) type.

The three-dimensional shaping device 100 includes a first dispensing unit 10a and a second dispensing unit 10b as the dispensing unit 10. In the shown example, the first dispensing unit 10a and the second dispensing unit 10b are arranged in the X-axis direction. The first dispensing unit 10a and the second dispensing unit 10b have the same configuration, for example. Both the first dispensing unit 10a and the second dispensing unit 10b may dispense the plasticizing material constituting the three-dimensional shaped object, or one of the first dispensing unit 10a and the second dispensing unit 10b may dispense the plasticizing material and the other one may dispense a support material supporting the three-dimensional shaped object. Although not shown, one of the first dispensing unit 10a and the second dispensing unit 10b may not be provided.

As shown in FIG. 2, the dispensing unit 10 includes, for example, a material storage unit 110, a plasticizing unit 120, a base unit 160, and a nozzle 170.

The material storage unit 110 stores a pellet-shaped or powder-shaped material. The material storage unit 110 supplies the material to the plasticizing unit 120. The material storage unit 110 is implemented by, for example, a hopper. The material stored in the material storage unit 110 is, for example, an acrylonitrile butadiene styrene (ABS) resin.

The material storage unit 110 and the plasticizing unit 120 are coupled by a supply path 112 provided below the material storage unit 110. The material charged into the material storage unit 110 is supplied to the plasticizing unit 120 through the supply path 112.

The plasticizing unit 120 includes, for example, a screw case 122, a drive motor 124, a flat screw 130, a barrel 140, and a heater 150. The plasticizing unit 120 plasticizes at least a part of the material in a solid state supplied from the material storage unit 110, generates a paste-shaped plasticizing material having fluidity, and supplies the plasticizing material to the nozzle 170.

The term “plasticize” is a concept including melting, and means changing from a solid state to a flowable state. Specifically, for a material in which glass transition occurs, the “plasticize” refers to setting a temperature of the material to be equal to or higher than a glass transition point. For a material in which the glass transition does not occur, the “plasticize” refers to setting the temperature of the material to be equal to or higher than a melting point.

The screw case 122 is a housing that houses the flat screw 130. The barrel 140 is provided on a lower surface of the screw case 122. The flat screw 130 is housed in a space surrounded by the screw case 122 and the barrel 140.

The drive motor 124 is provided on an upper surface of the screw case 122. The drive motor 124 is, for example, a servomotor. A shaft 126 of the drive motor 124 is coupled to an upper surface 131 of the flat screw 130. The drive motor 124 is controlled by the control unit 80. Although not shown, the shaft 126 of the drive motor 124 and the upper surface 131 of the flat screw 130 may be coupled via a speed reducer.

The flat screw 130 has a substantially cylindrical shape in which a size in a direction of a rotation axis R is smaller than a size in a direction orthogonal to the direction of the rotation axis R. In the shown example, the rotation axis R is parallel to the Z-axis. The flat screw 130 is rotated about the rotation axis R by a torque generated by the drive motor 124.

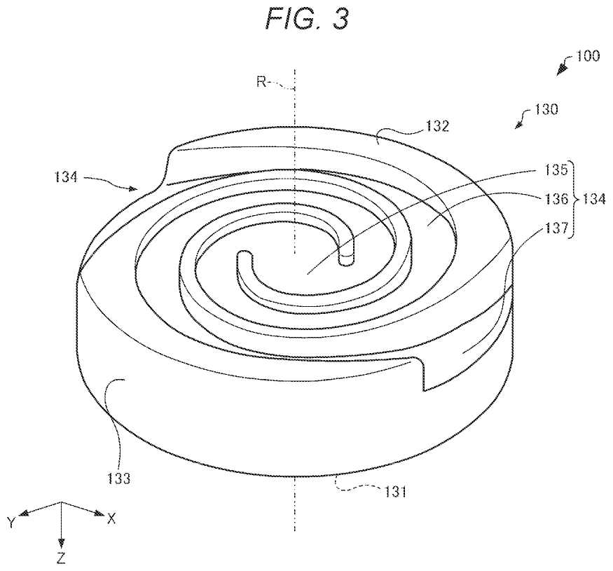

The flat screw 130 has the upper surface 131, a groove forming surface 132 opposite to the upper surface 131, and a side surface 133 coupling the upper surface 131 and the groove forming surface 132. A first groove 134 is formed in the groove forming surface 132. The side surface 133 is, for example, perpendicular to the groove forming surface 132. Here, FIG. 3 is a perspective view schematically showing the flat screw 130. For convenience, FIG. 3 shows a state in which an upper-lower positional relationship is reversed from a state shown in FIG. 2.

As shown in FIG. 3, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the shown example, the coupling portion 136 is provided in a spiral shape from the central portion 135 toward an outer periphery of the groove forming surface 132. The material introduction portion 137 is provided on the outer periphery of the groove forming surface 132. That is, the material introduction portion 137 is provided on the side surface 133 of the flat screw 130. The material supplied from the material storage unit 110 is introduced from the material introduction portion 137 into the first groove 134, passes through the coupling portion 136 and the central portion 135, and is conveyed to the communication hole 146 formed in the barrel 140. For example, two first grooves 134 are provided.

The number of the first grooves 134 is not particularly limited. Although not shown, three or more first grooves 134 may be formed, or only one first groove 134 may be formed.

Although not shown, the plasticizing unit 120 may include an elongated in-line screw having a spiral groove on a side surface thereof, instead of the flat screw 130. The plasticizing unit 120 may plasticize the material by rotation of the in-line screw.

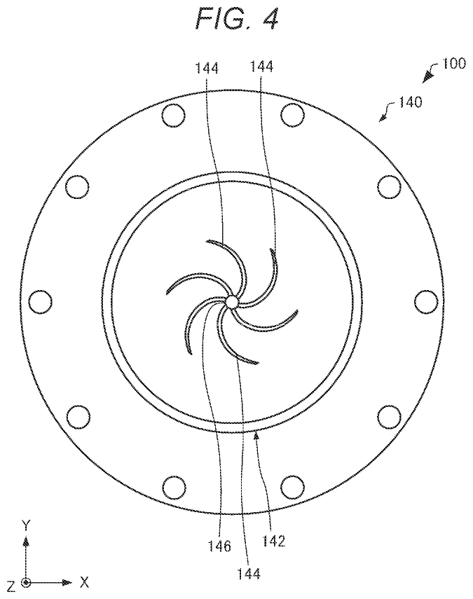

As shown in FIG. 2, the barrel 140 is provided below the flat screw 130. The barrel 140 has a facing surface 142 facing the groove forming surface 132 of the flat screw 130. The communication hole 146 communicating with the first groove 134 is formed in a center of the facing surface 142. Here, FIG. 4 is a plan view schematically showing the barrel 140.

As shown in FIG. 4, a second groove 144 and the communication hole 146 are formed in the facing surface 142 of the barrel 140. A plurality of the second grooves 144 are formed. In the shown example, six second grooves 144 are formed, and the number of the second grooves 144 is not particularly limited. The plurality of second grooves 144 are formed around the communication hole 146 when viewed from the Z-axis direction. One ends of the second grooves 144 are coupled to the communication hole 146, and the second grooves 144 extend spirally from the communication hole 146 toward an outer periphery of the barrel 140. The second grooves 144 have a: function of guiding the plasticized plasticizing material to the communication hole 146.

A shape of the second groove 144 is not particularly limited, and may be, for example, a linear shape. The one end of the second groove 144 may not be coupled to the communication hole 146. Further, the second groove 144 may not be formed in the facing surface 142. However, in consideration of efficiently guiding the plasticized material to the communication hole 146, the second groove 144 is preferably formed in the facing surface 142.

As shown in FIG. 2, the heater 150 is provided in the barrel 140. The heater 150 heats the material supplied between the flat screw 130 and the barrel 140. An output of the heater 150 is controlled by the control unit 80. The plasticizing unit 120 heats the material while conveying the material toward the communication hole 146 by the flat screw 130, the barrel 140, and the heater 150 to generate the plasticized plasticizing material. Then, the plasticizing unit 120 causes the generated plasticizing material to flow out from the communication hole 146.

When viewed from the Z-axis direction, the heater 150 may have a ring shape. The heater 150 may be provided below the barrel 140 instead of in the barrel 140.

The base unit 160 is provided below the barrel 140. The base unit 160 is fixed to the barrel 140. The base unit 160 is engaged with the nozzle 170. The base unit 160 is thermally expanded by, for example, heat of the heater 150. Specifically, when a temperature of the heater 150 becomes high, the base unit 160 thermally expands and a length of the base unit 160 in the Z-axis direction increases. Accordingly, a length of the dispensing unit 10 in the Z-axis direction increases. The base unit 160 is made of metal. The dispensing unit 10 may not include the base unit 160, and even in this case, the dispensing unit 10 has a larger length in the Z-axis direction due to the thermal expansion.

The nozzle 170 is provided below the base unit 160. A nozzle flow path 172 is formed in the nozzle 170. The nozzle flow path 172 communicates with the communication hole 146. The plasticizing material is supplied to the nozzle flow path 172 from the communication hole 146. The nozzle 170 dispenses, toward the stage 20, the plasticizing material supplied to the nozzle flow path 172 from a nozzle tip end 174. The nozzle tip end 174 is an end of the nozzle 170 in the −Z-axis direction.

The stage 20 is provided below the nozzle 170. The stage 20 includes, for example, a heat insulating member 21, a lower plate 22, a heater 23, an upper plate 24, and a shaping plate 25.

The heat insulating member 21 is provided on the position changing unit 30. The heat insulating member 21 is provided between the position changing unit 30 and the lower plate 22. A shape of the heat insulating member 21 is, for example, a plate shape. As the heat insulating member 21, for example, a loss rim board (registered trademark) is used. The heat insulating member 21 can reduce heat of the heater 23 transferred below the heat insulating member 21.

The lower plate 22 is provided on the heat insulating member 21. The lower plate 22 is provided between the heat insulating member 21 and the heater 23. A material of the lower plate 22 is, for example, aluminum. An upper surface and a lower surface of the lower plate 22 are, for example, polished mirror surfaces. Accordingly, the lower plate 22 can reflect radiant heat from the heater 23 to the shaping plate 25 side.

The heater 23 is provided on the lower plate 22. The heater 23 is provided between the lower plate 22 and the upper plate 24. The heater 23 is, for example, a plate-shaped heater plate. As the heater 23, for example, a rubber heater is used. The heater 23 heats the plasticizing material stacked on the shaping plate 25 via the upper plate 24 and the shaping plate 25. An output of the heater 23 is controlled by the control unit 80.

The upper plate 24 is provided on the heater 23. The upper plate 24 is provided between the heater 23 and the shaping plate 25. A material of the upper plate 24 is, for example, aluminum. For example, an oxide film is provided on an upper surface and a lower surface of the upper plate 24. By the oxide film, the radiant heat from the heater 23 can be easily accumulated, and the shaping plate 25 can be efficiently heated. The shaping plate 25 is configured to be detachable, for example. The upper plate 24 can prevent the heater 23 from being exposed when the shaping plate 25 is removed.

The shaping plate 25 is provided on the upper plate 24. The shaping plate 25 is provided between the upper plate 24 and the heating unit 50. A material of the shaping plate 25 is, for example, aluminum. The shaping plate 25 has a material stack surface 26 on which the plasticizing material is stacked. The material stack surface 26 is an upper surface of the shaping plate 25.

The position changing unit 30 supports the stage 20. The position changing unit 30 changes relative positions of the dispensing unit 10 and the stage 20. In the shown example, the position changing unit 30 changes relative positions of the nozzle 170 and the stage 20 in the X-axis direction and the Y-axis direction by moving the stage 20 in the X-axis direction and the Y-axis direction. Further, the position changing unit 30 changes the relative positions of the nozzle 170 and the stage 20 in the Z-axis direction by moving the dispensing unit 10 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the dispensing unit 10 in the Z-axis direction.

A configuration of the position changing unit 30 is not particularly limited as long as the relative positions of the dispensing unit 10 and the stage 20 can be changed. For example, the position changing unit 30 may move the stage 20 in the Z-axis direction and move the dispensing unit 10 in the X-axis direction and the Y-axis direction. The position changing unit 30 may move the stage 20 or the dispensing unit 10 in the X-axis direction, the Y-axis direction, and the Z-axis direction.

The support unit 40 is coupled to the third electric actuator 36. The support unit 40 supports the dispensing unit 10. The position changing unit 30 moves the dispensing unit 10 in the Z-axis direction by moving the support unit 40 in the Z-axis direction by the third electric actuator 36.

The heating unit 50 is provided above the material stack surface 26 of the shaping plate 25. The heating unit 50 is supported by the support unit 40. Although not shown, the support unit 40 may include a pair of support bowls extending in the Y-axis direction, and the heating unit 50 may be suspended and supported by the pair of support bowls. The heating unit 50 is moved in conjunction with the dispensing unit 10 by the position changing unit 30. That is, the position changing unit 30 changes relative positions of the heating unit 50 and the stage 20. The dispensing unit 10 is moved in conjunction with the heating unit 50 by the position changing unit 30.

A shape of the heating unit 50 is, for example, a plate shape. The heating unit 50 overlaps the material stack surface 26 when viewed from the Z-axis direction.

A through hole 52 is formed in the heating unit 50. The through hole 52 penetrates the heating unit 50 in the Z-axis direction. When the three-dimensional shaped object is shaped, the nozzle 170 of the dispensing unit 10 is positioned in the through hole 52. When the three-dimensional shaped object is shaped, the nozzle tip end 174 is positioned below the heating unit 50. In the shown example, two through holes 52 are formed corresponding to the two dispensing units 10.

The heating unit 50 includes, for example, a plate 54, a heater 56, and a heat insulating member 58.

The plate 54 faces the material stack surface 26. The plate 54 is provided between the material stack surface 26 and the heater 56. A material of the plate 54 is, for example, aluminum. The plate 54 is fixed to the heater 56 by, for example, an aluminum screw (not shown). The screw and the plate 54 are thermally expanded by, for example, heat of the heater 56. Specifically, when the temperature of the heater 56 becomes high, the screw and the plate 54 thermally expand, and sizes of the screw and the plate 54 in the Z-axis direction become long. Accordingly, a length of the heating unit 50 in the Z-axis direction increases.

The heater 56 is provided on the plate 54. The heater 56 is provided between the plate 54 and the heat insulating member 58. The heater 56 is, for example, a plate-shaped heater plate. As the heater 56, for example, a rubber heater is used. The heater 56 heats the plasticizing material stacked on the material stack surface 26 via the plate 54. An output of the heater 56 is controlled by the control unit 80.

The heat insulating member 58 is provided on the heater 56. The heat insulating member 58 is coupled to, for example, the support unit 40. A material of the heat insulating member 58 is, for example, the same as the material of the heat insulating member 21. The heat insulating member 58 can reduce heat of the heater 56 transferred above the heat insulating member 58.

The drive unit 60 is supported by the support unit 40. The drive unit 60 is coupled to, for example, the dispensing unit 10. The drive unit 60 changes relative positions of the nozzle 170 and the heating unit 50. For example, the drive unit 60 changes the relative positions of the nozzle 170 and the heating unit 50 in the Z-axis direction by moving the dispensing unit 10 in the Z-axis direction. For example, two drive units 60 are provided corresponding to the two dispensing units 10.

The drive unit 60 positions the nozzle tip end 174 below the heating unit 50 during shaping of the three-dimensional shaped object. The drive unit 60 may move the nozzle tip end 174 to above the heating unit 50 when the three-dimensional shaped object is not being shaped. The nozzle tip end 174 may be cleaned by a cleaning mechanism (not shown) in a state of being positioned above the heating unit 50. The cleaning mechanism includes, for example, a brush and a blade. The drive unit 60 includes, for example, a ball screw, a stepping motor, and a linear guide.

The drive unit 60 may change the relative positions of the nozzle 170 and the heating unit 50 in the Z-axis direction by moving the heating unit 50 in the Z-axis direction without moving the dispensing unit 10. Further, the drive unit 60 may change the relative positions of the nozzle 170 and the heating unit 50 in the Z-axis direction by moving both the dispensing unit 10 and the heating unit 50 in the Z-axis direction.

The temperature sensor 70 is provided above the stage 20. The temperature sensor 70 is positioned in a through hole 53 formed in the heating unit 50. The through hole 53 penetrates the heating unit 50 in the Z-axis direction. The through hole 53 is formed, for example, between the two through holes 52 when viewed from the Z-axis direction. The temperature sensor 70 moves as the heating unit 50 moves. The temperature sensor 70 is supported by, for example, the heating unit 50. The temperature sensor 70 measures a temperature of the plasticizing material stacked on the stage 20. The temperature sensor 70 is, for example, a thermocouple, a thermistor, or an infrared ray sensor.

For example, the control unit 80 is implemented by a computer including a processor, a main storage device, and an input and output interface that receives and outputs a signal from and to the outside. The control unit 80 exerts various functions by, for example, executing, by the processor, a program read into the main storage device. Specifically, the control unit 80 controls the dispensing unit 10, the position changing unit 30, the heating unit 50, and the drive unit 60. The control unit 80 may be implemented by a combination of a plurality of circuits instead of the computer.

Positions of the material stack surface 26, a lower surface of the heating unit 50, and the nozzle tip end 174 in the Z-axis direction may be measured by a touch sensor (not shown) supported by the stage 20 and a touch sensor (not shown) supported by the heating unit 50.

A remaining amount of the material stored in the material storage unit 110 may be detected by monitoring a load torque applied to the third electric actuator 36 of the position changing unit 30. When the remaining amount of the material decreases, the load torque applied to the third electric actuator 36 decreases. The material storage unit 110 can store, for example, about 2 liters of material.

### 1.2. Processing of Control Unit

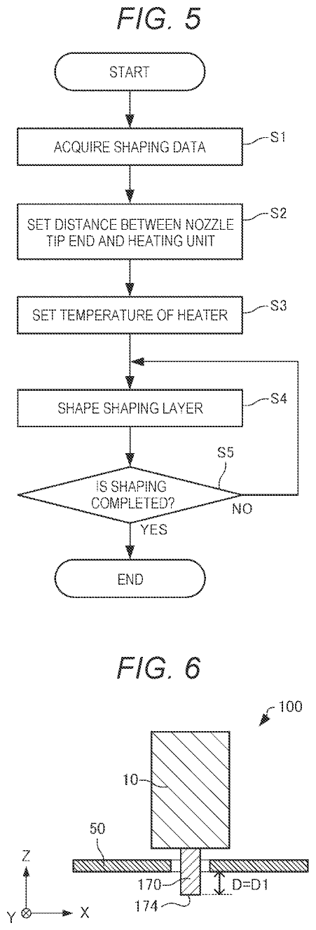

FIG. 5 is a flowchart showing processing of the control unit 80 of the three-dimensional shaping device 100. For example, a user operates an operation unit (not shown) to output, to the control unit 80, a processing start signal for starting the processing. The operation unit is implemented by, for example, a mouse, a keyboard, and a touch panel. When the processing start signal is received, the control unit 80 starts the processing.

First, as shown in FIG. 5, in step S1, the control unit 80 performs processing of acquiring shaping data for shaping a three-dimensional shaped object.

The shaping data includes, for example, information related to a type of the material stored in the material storage unit 110, a movement path of the dispensing unit 10 with respect to the stage 20, an amount of the plasticizing material dispensed from the dispensing unit 10, or the like.

The shaping data is created by, for example, causing a slicer software installed in a computer connected to the three-dimensional shaping device 100 to read shape data. The shape data is data representing a target shape of the three-dimensional shaped object created using three-dimensional computer aided design (CAD) software, three-dimensional computer graphics (CG) software, or the like. As the shape data, for example, data such as a standard triangulated language (STL) format or an additive manufacturing file format (AMF) is used. The slicer software divides the target shape of the three-dimensional shaped object into layers having a predetermined thickness and creates shaping data for each layer. The shaping data is represented by a G code, an M code, or the like. The control unit 80 acquires shaping data from a computer or a recording medium such as a universal serial bus (USB) memory connected to the three-dimensional shaping device 100.

Next, as shown in step S2, the control unit 80 controls the drive unit 60 to perform processing of setting a distance between the nozzle tip end 174 and the heating unit 50 based on at least one of a temperature of the dispensing unit 10, a temperature of the heating unit 50, and a distance between the stage 20 and the nozzle tip end 174. Hereinafter, a case where the distance between the nozzle tip end 174 and the heating unit 50 is set based on the temperature of the dispensing unit 10 will be described.

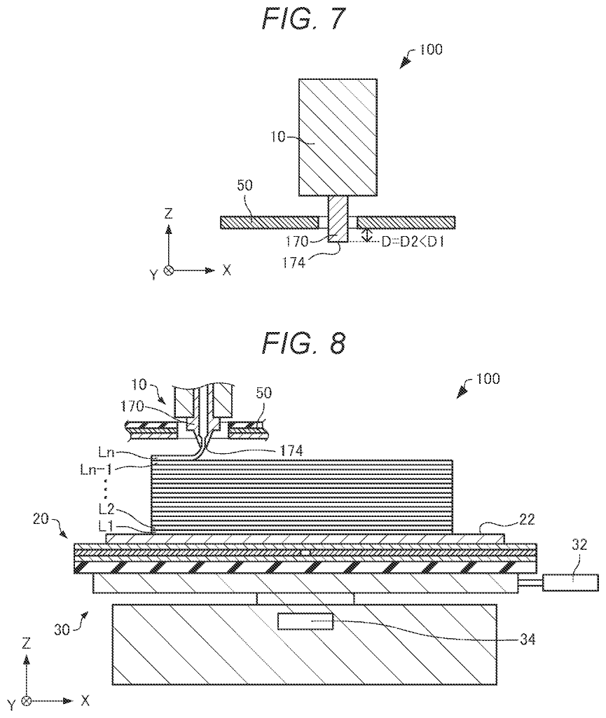

Here, FIGS. 6 and 7 are cross-sectional views showing processing of step S2 performed by the control unit 80 of the three-dimensional shaping device 100. For convenience, in FIGS. 6 and 7, the dispensing unit 10 and the heating unit 50 are shown in a simplified manner.

When a temperature of the heater 150 of the dispensing unit 10 is set to a first temperature in the next step S3, the control unit 80 controls the drive unit 60 to set a distance D between the nozzle tip end 174 and the heating unit 50 to a first distance D1 as shown in FIG. 6. When the temperature of the heater 150 is set to a second temperature higher than the first temperature in the next step S3, the control unit 80 controls the drive unit 60 to set the distance D to a second distance D2 smaller than the first distance D1 as shown in FIG. 7. The distance D is a shortest distance between the nozzle tip end 174 and the heating unit 50 in the Z-axis direction. The distance D is an amount of downward protrusion of the nozzle 170 from the heating unit 50.

When the temperature of the heater 150 is set to the second temperature, a thermal expansion amount of the dispensing unit 10 in the Z-axis direction is increased due to the heat of the heater 150 as compared with the case where the temperature of the heater 150 is set to the first temperature. Accordingly, by setting the distance D to the second distance D2 smaller than the first distance D1, it is possible to reduce a difference between the distance D when the temperature of the heater 150 is set to the first temperature and the distance D when the temperature of the heater 150 is set to the second temperature in processing of shaping a shaping layer. The control unit 80 may set the distance D to be smaller as a set temperature of the heater 150 is higher.

The control unit 80 may set the distance D based on a correlation table indicating a relationship between the temperature of the heater 150 and the thermal expansion amount of the dispensing unit 10 due to the heat of the heater 150. The control unit 80 may determine the first distance D1 and the second distance D2 based on the table. The table may be stored in a storage unit (not shown). The storage unit is implemented by, for example, a random access memory (RAM) and a read only memory (ROM).

Next, as shown in FIG. 5, the control unit 80 performs processing of setting the temperatures of the heaters 23, 56, and 150 based on the shaping data as shown in step S3. Specifically, the control unit 80 sets the temperatures of the heaters 23, 56, and 150 based on information related to the types of materials included in the shaping data.

Next, in step S4, the control unit 80 performs processing of dispensing the plasticizing material to the material stack surface 26 of the stage 20 to shape the shaping layer.

Specifically, the control unit 80 plasticizes the material supplied between the flat screw 130 and the barrel 140 to generate the plasticizing material, and dispenses the plasticizing material from the nozzle 170 of the dispensing unit 10. For example, the control unit 80 continues to generate the plasticizing material until the processing of shaping the shaping layer is completed.

Here, FIG. 8 is a cross-sectional view showing the processing of shaping the shaping layer by the control unit 80 of the three-dimensional shaping device 100.

As shown in FIG. 8, based on the acquired shaping data, the control unit 80 controls the position changing unit 30 to change the relative positions of the dispensing unit 10 and the stage 20, and controls the dispensing unit 10 to dispense the plasticizing material from the nozzle 170 toward the stage 20.

Specifically, before shaping layer forming processing is started, that is, before formation of a shaping layer L1 which is a first shaping layer is started, the nozzle 170 is disposed at an initial position in the −X-axis direction of an end portion of the stage 20 in the −X-axis direction. When the processing of shaping the shaping layer is started, as shown in FIG. 7, the control unit 80 controls the position changing unit 30 to, for example, move the nozzle 170 in the +X-axis direction relative to the stage 20. When the nozzle 170 passes over the stage 20, the plasticizing material is dispensed from the nozzle 170. Accordingly, the shaping layer L1 is formed. In FIG. 8, n is any natural number, and up to an n-th shaping layer Ln are shown.

The control unit 80 may set the distance D between the nozzle tip end 174 and the heating unit 50 based on a measurement result of the temperature sensor 70 while performing the processing of shaping the shaping layer in step S4. The control unit 80 may repeatedly set the distance D based on the temperature sensor 70 until the processing of shaping the shaping layer is completed.

For example, when the temperature measured by the temperature sensor 70 is higher than a predetermined value, the control unit 80 controls the drive unit 60 to increase the distance D between the nozzle tip end 174 and the heating unit 50. Accordingly, a distance between an uppermost layer of the plasticizing material stacked on the stage 20 and the heating unit 50 can be increased, and thus a temperature of the uppermost layer of the plasticizing material stacked on the stage 20 can be brought close to a desired value.

For example, when the temperature measured by the temperature sensor 70 is lower than a predetermined value, the control unit 80 controls the drive unit 60 to reduce the distance D between the nozzle tip end 174 and the heating unit 50. Accordingly, the distance between the uppermost layer of the plasticizing material stacked on the stage 20 and the heating unit 50 can be reduced, and thus the temperature of the uppermost layer of the plasticizing material stacked on the stage 20 can be brought close to the desired value.

Next, as shown in FIG. 5, in step S5, the control unit 80 performs determination processing of determining, based on the shaping data, whether the shaping of all the shaping layers is completed.

When it is determined that the shaping of all the shaping layers is not completed (“NO” in step S5), the control unit 80 returns the processing to step S4. The control unit 80 repeats steps S4 and S5 until it is determined that the shaping of all the shaping layers is completed in step S5.

On the other hand, when it is determined that the shaping of all the shaping layers is completed (“YES” in step S5), the control unit 80 ends the processing.

Before the processing of shaping the shaping layer, the control unit 80 may perform the processing of setting the distance D between the nozzle tip end 174 and the heating unit 50 after the processing of setting the temperatures of the heaters 23, 56, and 150. In this case, the control unit 80 does not control the drive unit 60 such that the distance D after the dispensing unit 10 is thermally expanded due to the heater 150 becomes the first distance D1 or the second distance D2, but controls the drive unit 60 such that the distance D in a state before the dispensing unit 10 is thermally expanded due to the heater 150 becomes the first distance D1 or the second distance D2. As described above, setting of the distance D to a predetermined distance means that the distance D in a state before members constituting the three-dimensional shaping device 100 are thermally expanded is controlled to be the predetermined distance.

### 1.3. Operation and Effect

In the three-dimensional shaping device 100, the control unit 80 controls the drive unit 60 to set the distance D between the nozzle tip end 174 and the heating unit 50 based on at least one of the temperature of the dispensing unit 10, the temperature of the heating unit 50, and the distance between the stage 20 and the nozzle tip end 174. Therefore, in the three-dimensional shaping device 100, for example, the distance D can be made closer to the desired value than when the distance D is set without considering any of the temperature of the dispensing unit 10, the temperature of the heating unit 50, and the distance between the stage 20 and the nozzle tip end 174. Accordingly, it is possible to improve shaping accuracy of the three-dimensional shaped object.

In the three-dimensional shaping device 100, the control unit 80 sets the distance D between the nozzle tip end 174 and the heating unit 50 to the first distance when setting the temperature of the heater 150 as a first heater to the first temperature, and sets the distance D to the second distance smaller than the first distance when setting the temperature of the heater 150 to the second temperature higher than the first temperature. Therefore, in the three-dimensional shaping device 100, as described above, it is possible to reduce the difference between the distance D when the temperature of the heater 150 is set to the first temperature and the distance D when the temperature of the heater 150 is set to the second temperature in the processing of shaping the shaping layer. For example, the difference can be reduced to 20 μm or less. Accordingly, it is possible to reduce an influence of the thermal expansion of the dispensing unit 10 due to the temperature of the heater 150 on the shaping accuracy of the three-dimensional shaped object. Accordingly, it is possible to improve the shaping accuracy of the three-dimensional shaped object.

In the three-dimensional shaping device 100, the control unit 80 sets the distance D between the nozzle tip end 174 and the heating unit 50 based on the measurement result of the temperature sensor 70. Therefore, in the three-dimensional shaping device 100, as described above, the temperature of the plasticizing material stacked on the stage 20 can be brought close to a desired value.

### 2. Modification of Three-Dimensional Shaping Device

### 2.1. First Modification

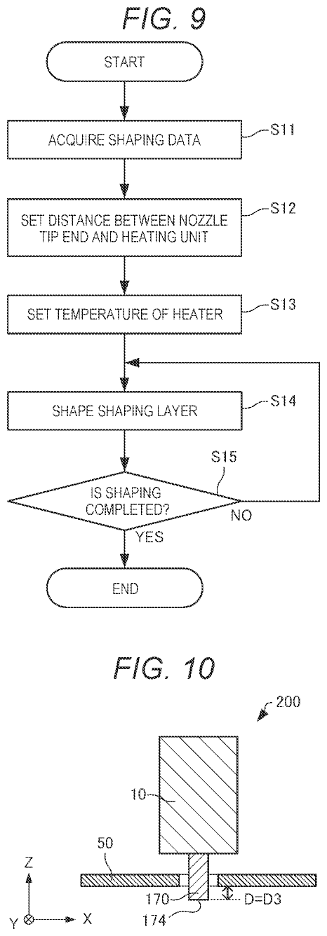

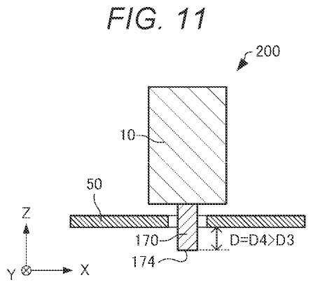

Next, a three-dimensional shaping device according to a first modification of the embodiment will be described with reference to the drawings. FIG. 9 is a flowchart showing the processing of the control unit 80 of a three-dimensional shaping device 200 according to the first modification of the embodiment. FIGS. 10 and 11 are cross-sectional views showing the processing of the control unit 80 of the three-dimensional shaping device 200 according to the first modification of the embodiment. For convenience, in FIGS. 10 and 11, the dispensing unit 10 and the heating unit 50 are shown in a simplified manner.

Hereinafter, in the three-dimensional shaping device 200 according to the first modification of the embodiment, members having the same functions as constituent members of the three-dimensional shaping device 100 according to the embodiment described above are denoted by the same reference numerals, and detailed description thereof is omitted. This is the same in three-dimensional shaping devices according to second to fourth modifications of the embodiment to be described later.

In the three-dimensional shaping device 100 described above, in the processing of setting the distance D between the nozzle tip end 174 and the heating unit 50 in step S2 shown in FIG. 5, the distance D is set based on the temperature of the dispensing unit 10.

In contrast, in the three-dimensional shaping device 200, in step S12 shown in FIG. 9, the distance D between the nozzle tip end 174 and the heating unit 50 is set based on the temperature of the heating unit 50. Steps S11 and S13 to S15 are basically the same as steps S1 and S3 to S5 shown in FIG. 5, respectively.

When the temperature of the heater 56 of the heating unit 50 is set to a third temperature in the next step S13, the control unit 80 controls the drive unit 60 to set the distance D between the nozzle tip end 174 and the heating unit 50 to a third distance D3 as shown in FIG. 10. When the temperature of the heater 56 is set to a fourth temperature higher than the third temperature in the next step S13, the control unit 80 controls the drive unit 60 to set the distance D to a fourth distance D4 larger than the third distance D3 as shown in FIG. 11.

When the temperature of the heater 56 is set to the fourth temperature, a thermal expansion amount of the heating unit 50 in the Z-axis direction is increased due to the heat of the heater 56 as compared with the case where the temperature of the heater 56 is set to the third temperature. Accordingly, by setting the distance D to the fourth distance D4 larger than the third distance D3, it is possible to reduce the difference between the distance D when the temperature of the heater 56 is set to the third temperature and the distance D when the temperature of the heater 56 is set to the fourth temperature in processing of shaping a shaping layer. For example, the control unit 80 may set the distance D to be larger as a set temperature of the heater 56 is higher.

The control unit 80 may set the distance D based on a correlation table indicating a relationship between the temperature of the heater 56 and the thermal expansion amount of the heating unit 50 due to the heat of the heater 56. The control unit 80 may determine the third distance D3 and the fourth distance D4 based on the table. The table may be stored in a storage unit (not shown).

The three-dimensional shaping device 200 has, for example, the following operations and effects.

In the three-dimensional shaping device 200, the control unit 80 sets the distance D between the nozzle tip end 174 and the heating unit 50 to the third distance D3 when setting the temperature of the heater 56 as a second heater to the third temperature, and sets the distance D to the fourth distance D4 larger than the third distance D3 when setting the temperature of the heater 56 to the fourth temperature higher than the third temperature. Therefore, in the three-dimensional shaping device 200, as described above, it is possible to reduce the difference between the distance D when the temperature of the heater 56 is set to the third temperature and the distance D when the temperature of the heater 56 is set to the fourth temperature in the processing of shaping the shaping layer. Accordingly, it is possible to reduce an influence of the thermal expansion of the heating unit 50 due to the temperature of the heater 56 on the shaping accuracy of the three-dimensional shaped object. Accordingly, it is possible to improve the shaping accuracy of the three-dimensional shaped object.

When the temperature of the heater 150 of the dispensing unit 10 is higher than the temperature of the heater 56 of the heating unit 50, the thermal expansion amount of the dispensing unit 10 is larger than the thermal expansion amount of the heating unit 50, and thus the described processing of the control unit 80 may be prioritized in the three-dimensional shaping device 100.

When the temperature of the heater 150 of the dispensing unit 10 and the temperature of the heater 56 of the heating unit 50 are substantially the same and a change amount of the distance D due to the thermal expansion amount of the dispensing unit 10 and a change amount of the distance D due to the thermal expansion amount of the heating unit 50 can cancel each other out to make the distance D to fall within a predetermined range, the control unit 80 may not adjust the distance D.

### 2.2. Second Modification

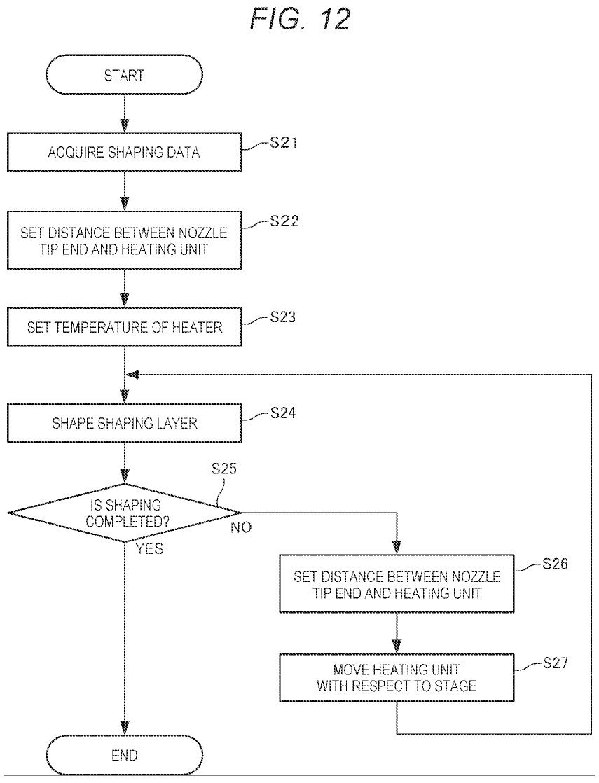

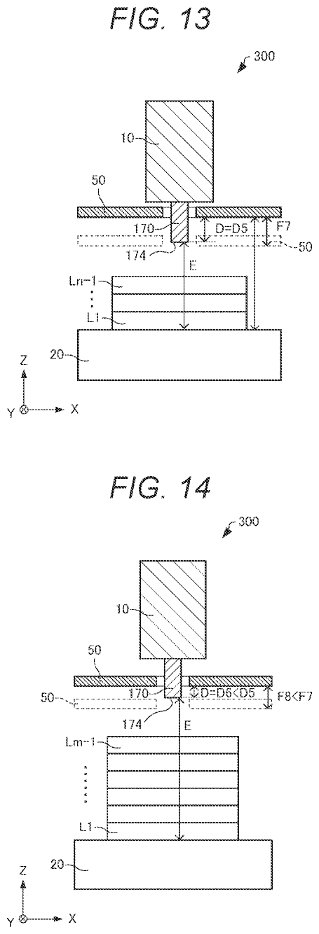

Next, a three-dimensional shaping device according to a second modification of the embodiment will be described with reference to the drawings. FIG. 12 is a flowchart showing processing of the control unit 80 of a three-dimensional shaping device 300 according to the second modification of the embodiment. FIGS. 13 and 14 are cross-sectional views showing the processing of the control unit 80 of the three-dimensional shaping device 300 according to the second modification of the embodiment. For convenience, in FIGS. 13 and 14, the dispensing unit 10, the stage 20, and the heating unit 50 are shown in a simplified manner. The control unit 80 of the three-dimensional shaping device 300 is different from the control unit of the three-dimensional shaping device 100 described above in that when it is determined that formation of all shaping layers is not completed (“NO” in step S25), the processing proceeds to step S26 as shown in FIG. 12. Steps S21 to S25 are basically the same as steps S1 to S5 shown in FIG. 5, respectively.

In step S26, the control unit 80 sets the distance D between the nozzle tip end 174 and the heating unit 50 based on a distance E between the stage 20 and the nozzle tip end 174.

Here, n is a natural number, and m is a natural number larger than n. n is, for example, a natural number of 2 or more.

When an n-th layer of the three-dimensional shaped object is shaped in the next step S24, the control unit 80 controls the drive unit 60 to set the distance D between the nozzle tip end 174 and the heating unit 50 to a fifth distance D5 as shown in FIG. 13. When an m-th layer of the three-dimensional shaped object is shaped in the next step S24, the control unit 80 controls the drive unit 60 to set the distance D to a sixth distance D6 smaller than the fifth distance D5 as shown in FIG. 14. When the m-th layer is shaped, the distance E between the stage 20 and the nozzle tip end 174 is larger than when the n-th layer is shaped. Accordingly, the control unit 80 sets the distance D based on the distance E. The distance E is a shortest distance between the stage 20 and the nozzle tip end 174 in the Z-axis direction.

When the m-th layer is shaped, a distance between an uppermost layer of the three-dimensional shaped object and the stage 20 is larger than when the n-th layer is shaped. Therefore, when the m-th layer is shaped, the uppermost layer of the three-dimensional shaped object is less likely to be heated by the heater 23 of the stage 20 as compared with the case where the n-th layer is shaped. Accordingly, by setting the distance D between the nozzle tip end 174 and the heating unit 50 to the sixth distance D6 smaller than the fifth distance D5, the influence of the heating of the heating unit 50 on the uppermost layer of the three-dimensional shaped object is increased. As a result, in the processing of shaping the shaping layer, it is possible to reduce a difference, in the temperature of the uppermost layer of the three-dimensional shaped object stacked on the stage 20, between the case of shaping the n-th layer and the case of shaping the m-th layer. Further, for example, when the n-th layer is shaped, the distance D is larger than when the m-th layer is shaped, and thus it is possible to prevent the uppermost layer of the three-dimensional shaped object from being heated more than necessary by the heater 56 of the heating unit 50 and the heater 23 of the stage 20.

The control unit 80 may reduce the distance D as the number of shaping layers of the three-dimensional shaped object increases. In this case, the control unit 80 may reduce the distance D at a constant rate or reduce the distance D in a quadratic function manner as the number of shaping layers of the three-dimensional shaped object increases.

The control unit 80 may set the distance D based on a correlation table indicating a relationship between the distance D between the nozzle tip end 174 and the heating unit 50 and the distance E between the stage 20 and the nozzle tip end 174. The table may be stored in a storage unit (not shown).

Next, as shown in FIG. 12, in step S27, the control unit 80 performs processing of moving the heating unit 50 with respect to the stage 20.

When an (n−1)-th layer of the three-dimensional shaped object is shaped in the previous step S24, the control unit 80 controls the position changing unit 30 to move the heating unit 50 in a direction relatively away from the stage 20 by a seventh distance F7 as shown in FIG. 13. In the shown example, the control unit 80 moves the heating unit 50 upward by the seventh distance F7. In FIG. 13, the heating unit 50 in a state of before being moved is indicated by a broken line. Then, in step S24, the control unit 80 shapes the n-th layer of the three-dimensional shaped object.

When an (m−1)-th layer of the three-dimensional shaped object is shaped in the previous step S24, the control unit 80 controls the position changing unit 30 to move the heating unit 50 in a direction relatively away from the stage 20 by an eighth distance F8, which is smaller than the seventh distance F7, as shown in FIG. 14. In the shown example, the control unit 80 moves the heating unit 50 upward by the eighth distance F8. In FIG. 14, the heating unit 50 in a state of before being moved is indicated by a broken line. Then, in step S24, the control unit 80 shapes the m-th layer of the three-dimensional shaped object.

In step S26 described above, when the m-th layer of the three-dimensional shaped object is shaped, the control unit 80 sets the distance D between the nozzle tip end 174 and the heating unit 50 to the sixth distance D6 smaller than the fifth distance D5. Therefore, if the heating unit 50 is moved upward by the seventh distance F7 with respect to the stage 20 after the (m−1)-th layer is shaped, when the m-th layer is shaped, the distance between the uppermost layer of the plasticizing material stacked on the stage 20 and the nozzle tip end 174 is larger than when the n-th layer is shaped. Accordingly, when the (m−1)-th layer of the three-dimensional shaped object is shaped, it is possible to reduce a difference, in the distance between the uppermost layer of the plasticizing material stacked on the stage 20 and the nozzle tip end 174, between a case where the n-th layer is shaped and a case where the m-th layer is shaped, by moving the heating unit 50 upward by the eighth distance F8, which is smaller than the seventh distance F7, with respect to the stage 20.

The shaping layer of the three-dimensional shaped object may be shaped by moving the dispensing unit 10 in the Z-axis direction by the drive unit 60 without moving the heating unit 50 in the Z-axis direction until the distance D between the nozzle tip end 174 and the heating unit 50 reaches a predetermined value.

The three-dimensional shaping device 300 has, for example, the following operations and effects.

In the three-dimensional shaping device 300, the control unit 80 sets the distance D between the nozzle tip end 174 and the heating unit 50 to the fifth distance D5 when shaping the n-th layer of the three-dimensional shaped object, and sets the distance D to the sixth distance D6 smaller than the fifth distance D5 when shaping the m-th layer of the three-dimensional shaped object. Therefore, in the three-dimensional shaping device 300, as described above, in the processing of shaping the shaping layer, it is possible to reduce the difference, in the temperature of the uppermost layer of the three-dimensional shaped object stacked on the stage 20, between the case of shaping the n-th layer and the case of shaping the m-th layer. Accordingly, it is possible to improve shaping accuracy of the three-dimensional shaped object.

In the three-dimensional shaping device 300, when the (n−1)-th layer of the three-dimensional shaped object is shaped, the control unit 80 controls, before shaping the n-th layer of the three-dimensional shaped object, the position changing unit 30 to move the heating unit 50 in a direction relatively away from the stage 20 by the seventh distance F7. When the (m−1)-th layer of the three-dimensional shaped object is shaped, the control unit 80 controls, before shaping the m-th layer of the three-dimensional shaped object, the position changing unit 30 to move the heating unit 50 in a direction relatively away from the stage 20 by the eighth distance F8 which is smaller than the seventh distance F7. Therefore, in the three-dimensional shaping device 300, as described above, it is possible to reduce the difference, in the distance between the uppermost layer of the plasticizing material stacked on the stage 20 and the nozzle tip end 174, between the case of shaping the n-th layer and the case of shaping the m-th layer. Accordingly, it is possible to improve shaping accuracy of the three-dimensional shaped object.

### 2.3. Third Modification

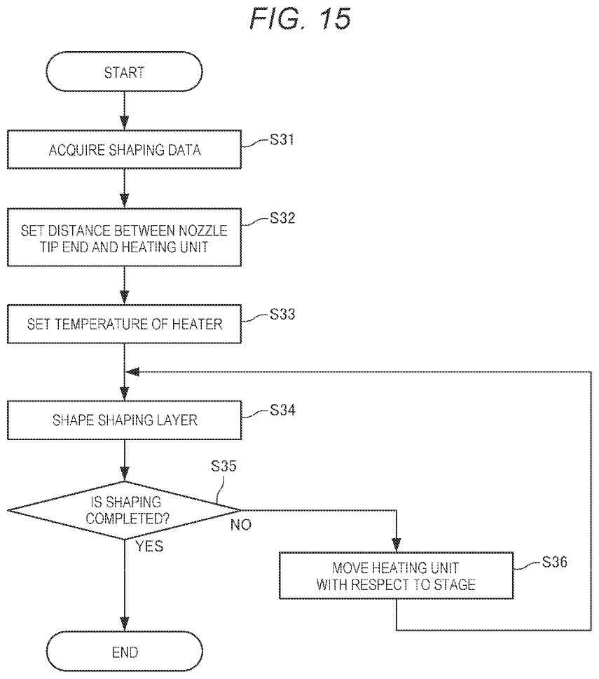

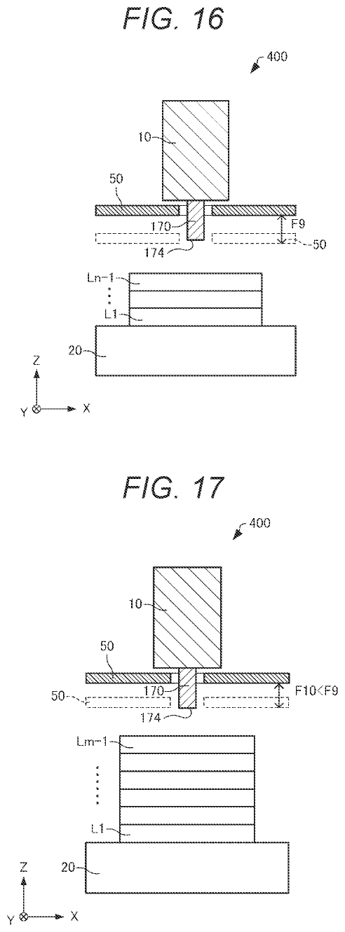

Next, a three-dimensional shaping device according to a third modification of the embodiment will be described with reference to the drawings. FIG. 15 is a flowchart showing processing of the control unit 80 of a three-dimensional shaping device 400 according to the third modification of the embodiment. FIGS. 16 and 17 are cross-sectional views showing the processing of the control unit 80 of the three-dimensional shaping device 400 according to the third modification of the embodiment. For convenience, in FIGS. 16 and 17, the dispensing unit 10, the stage 20, and the heating unit 50 are shown in a simplified manner.

The control unit 80 of the three-dimensional shaping device 400 is different from the control unit of the three-dimensional shaping device 100 described above in that when it is determined that formation of all shaping layers is not completed (“NO” in step S35), the processing proceeds to step S36 as shown in FIG. 15. Steps S31 to S35 are basically the same as steps S1 to S5 described above, respectively.

When an (n−1)-th layer of the three-dimensional shaped object is shaped in the previous step S34, in step S36, the control unit 80 controls the position changing unit 30 to move the heating unit 50 in a direction relatively away from the stage 20 by a ninth distance F9 as shown in FIG. 16. In the shown example, the control unit 80 moves the heating unit 50 upward by the ninth distance F9. In FIG. 16, the heating unit 50 in a state of before being moved is indicated by a broken line. Then, in step S34, the control unit 80 shapes the n-th layer of the three-dimensional shaped object.

When an (m−1)-th layer of the three-dimensional shaped object is shaped in the previous step S34, in step S36, the control unit 80 controls the position changing unit 30 to move the heating unit 50 in a direction relatively away from the stage 20 by a tenth distance F10, which is smaller than the ninth distance F9, as shown in FIG. 17. In the shown example, the control unit 80 moves the heating unit 50 upward by the tenth distance F10. In FIG. 17, the heating unit 50 in a state of before being moved is indicated by a broken line. Then, in step S34, the control unit 80 shapes the m-th layer of the three-dimensional shaped object.

When the m-th layer is shaped, the distance between the stage 20 and the heating unit 50 is larger than when the n-th layer is shaped. Therefore, when the m-th layer is shaped, the thermal expansion amount of the heating unit 50 in the Z-axis direction due to the heater 23 of the stage 20 is smaller than when the n-th layer is shaped. Accordingly, when the (m−1)-th layer of the three-dimensional shaped object is shaped, it is possible to reduce a difference, in the distance between the uppermost layer of the plasticizing material stacked on the stage 20 and the heating unit 50, between the case of shaping the n-th layer and the case of shaping the m-th layer, by moving the heating unit 50 in a direction relatively away from the stage 20 by the tenth distance F10 which is smaller than the ninth distance F9.

The three-dimensional shaping device 400 has, for example, the following operations and effects.

In the three-dimensional shaping device 400, when the (n−1)-th layer of the three-dimensional shaped object is shaped, the control unit 80 controls, before shaping the n-th layer of the three-dimensional shaped object, the position changing unit 30 to move the heating unit 50 in a direction relatively away from the stage 20 by the ninth distance F9. When the (m−1)-th layer of the three-dimensional shaped object is shaped, the control unit 80 controls, before shaping the m-th layer of the three-dimensional shaped object, the position changing unit 30 to move the heating unit 50 in a direction relatively away from the stage 20 by the tenth distance F10 which is smaller than the ninth distance F9. Therefore, in the three-dimensional shaping device 400, as described above, it is possible to reduce the difference, in the distance between the uppermost layer of the plasticizing material stacked on the stage 20 and the heating unit 50, between the case of shaping the n-th layer and the case of shaping the m-th layer. Accordingly, it is possible to improve shaping accuracy of the three-dimensional shaped object.

### 2.4. Fourth Modification

Next, a three-dimensional shaping device according to a fourth modification of the embodiment will be described.

In the three-dimensional shaping device 100 described above, the material stored in the material storage unit 110 is an ABS resin.

On the other hand, in the three-dimensional shaping device according to the fourth modification of the embodiment, the material stored in the material storage unit 110 is a material other than the ABS resin, or a material obtained by adding another component to the ABS resin.

Examples of the material stored in the material storage unit 110 can include various materials such as a thermoplastic material, a metal material, and a ceramic material as main materials. Here, the term “main material” means a material serving as a center that forms a shape of a shaped object shaped by the three-dimensional shaping device, and means a material that accounts for a content of 50 mass % or more in the shaped object. The materials described above include those materials obtained by melting these main materials alone, and those materials obtained by melting the main materials and a part of contained components into a paste shape.

As the thermoplastic material, for example, a thermoplastic resin can be used. Examples of the thermoplastic resin include general-purpose engineering plastics and super engineering plastics.

Examples of the general-purpose engineering plastic include polypropylene (PP), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

In addition to a pigment, a metal, and a ceramic, an additive such as a wax, a flame retardant, an antioxidant, and a heat stabilizer may be mixed into the thermoplastic material. In the plasticizing unit 120, the thermoplastic material is plasticized and converted into a molten state by rotation of the flat screw 130 and heating of the heater 150. The plasticizing material generated in this manner is deposited from the nozzle 170, and then is cured due to a decrease in temperature. It is desirable that the thermoplastic material is dispensed from the nozzle 170 in a completely molten state by being heated to a glass transition point or higher.

In the plasticizing unit 120, for example, a metal material may be used as a main material instead of the above-described thermoplastic material. In this case, it is desirable that a powder material obtained by powdering the metal material is mixed with a component that melts when the plasticizing material is generated, and the mixture is fed into the plasticizing unit 120.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material stored in the material storage unit 110 may be a mixed material obtained by mixing a plurality of types of powder of the single metal, powder of the alloy, or powder of the ceramic material. The powder material made of the metal material or the ceramic material may be coated with, for example, the thermoplastic resin described above or another thermoplastic resin. In this case, in the plasticizing unit 120, the thermoplastic resin may be melted to exhibit fluidity.

For example, a solvent can be added to the powder material of the metal material or the ceramic material stored in the material storage unit 110. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, a binder may be added to the powder material of the metal material or the ceramic material stored in the material storage unit 110. Examples of the binder include an acrylic resin, an epoxy resin, a silicone resin, a cellulose-based resin, other synthetic resins, PLA, PA, PPS, PEEK, and other thermoplastic resins.

The above embodiment and modifications are examples, and the present disclosure is not limited thereto. For example, the embodiment and the modifications may be combined as appropriate.

For example, the control unit 80 may set the distance D between the nozzle tip end 174 and the heating unit 50 based on the temperature of the dispensing unit 10, the temperature of the heating unit 50, and the distance E between the stage 20 and the nozzle tip end 174. In addition, the control unit 80 may set the distance D based on the temperature of the dispensing unit 10 and the temperature of the heating unit 50. In addition, the control unit 80 may set the distance D based on the temperature of the heating unit 50 and the distance E.

The present disclosure includes substantially the same configuration, for example, a configuration having the same function, method, and result, or a configuration having the same object and effect, as the configuration described in the embodiment. The present disclosure includes a configuration in which a non-essential portion of the configuration described in the embodiment is replaced. The present disclosure includes a configuration capable of achieving the same operation and effect or a configuration capable of achieving the same object as the configuration described in the embodiment. The present disclosure includes a configuration obtained by adding a known technique to the configuration described in the embodiment.

The following contents are derived from the embodiment and modifications described above.

A three-dimensional shaping device according to an aspect includes:
a dispensing unit including a plasticizing unit that includes a first heater and plasticizes a material to generate a plasticizing material, and a nozzle that dispenses the plasticizing material;
a stage on which the plasticizing material is stacked;
a heating unit including a second heater that heats the plasticizing material stacked on the stage;
a drive unit configured to change a relative position between the nozzle and the heating unit; and
a control unit configured to control the drive unit, in which
a tip end of the nozzle is positioned below the heating unit during shaping of a three-dimensional shaped object, and
the control unit controls the drive unit to set a distance between the tip end of the nozzle and the heating unit based on at least one of a temperature of the dispensing unit, a temperature of the heating unit, and a distance between the stage and the tip end of the nozzle.

According to the three-dimensional shaping device, it is possible to improve shaping accuracy of the three-dimensional shaped object.

In the three-dimensional shaping device according to the aspect,
the control unit may set the distance between the tip end of the nozzle and the heating unit to a first distance when setting a temperature of the first heater to a first temperature, and set the distance between the tip end of the nozzle and the heating unit to a second distance smaller than the first distance when setting the temperature of the first heater to a second temperature higher than the first temperature.

According to the three-dimensional shaping device, in processing of shaping a shaping layer, it is possible to reduce a difference between the distance between the tip end of the nozzle and the heating unit when the temperature of the first heater is set to the first temperature and the distance between the tip end of the nozzle and the heating unit when the temperature of the first heater is set to the second temperature.

In the three-dimensional shaping device according to the aspect,
the control unit may set the distance between the tip end of the nozzle and the heating unit to a third distance when setting a temperature of the second heater to a third temperature, and set the distance between the tip end of the nozzle and the heating unit to a fourth distance larger than the third distance when setting the temperature of the second heater to a fourth temperature higher than the third temperature.

According to the three-dimensional shaping device, in processing of shaping a shaping layer, it is possible to reduce a difference between the distance between the tip end of the nozzle and the heating unit when the temperature of the second heater is set to the third temperature and the distance between the tip end of the nozzle and the heating unit when the temperature of the second heater is set to the fourth temperature.

In the three-dimensional shaping device according to the aspect,
the stage may include a third heater, and
the control unit may set the distance between the tip end of the nozzle and the heating unit to a fifth distance when shaping an n-th layer of the three-dimensional shaped object, and set the distance between the tip end of the nozzle and the heating unit to a sixth distance smaller than the fifth distance when shaping an m-th layer of the three-dimensional shaped object, n being a natural number, and m being a natural number larger than n.

According to the three-dimensional shaping device, in the processing of shaping the shaping layer, it is possible to reduce a difference, in a temperature of an uppermost layer of the three-dimensional shaped object stacked on the stage, between the case of shaping the n-th layer and the case of shaping the m-th layer.

The three-dimensional shaping device according to the aspect may further include:
a position changing unit configured to change a relative position between the heating unit and the stage, in which
the dispensing unit may be moved by the position changing unit according to movement of the heating unit,
when an (n−1)-th layer of the three-dimensional shaped object is shaped, the control unit may control, before shaping the n-th layer of the three-dimensional shaped object, the position changing unit to move the heating unit in a direction relatively away from the stage by a seventh distance, n being a natural number of 2 or more, and
when an (m−1)-th layer of the three-dimensional shaped object is shaped, the control unit may control, before shaping the m-th layer of the three-dimensional shaped object, the position changing unit to move the heating unit in a direction relatively away from the stage by an eighth distance smaller than the seventh distance.

According to the three-dimensional shaping device, it is possible to reduce a difference, in a distance between the uppermost layer of the plasticizing material stacked on the stage and the tip end of the nozzle, between the case of shaping the n-th layer and the case of shaping the m-th layer.

The three-dimensional shaping device according to the aspect may further include:
a temperature sensor configured to measure a temperature of the plasticizing material stacked on the stage, in which
the control unit may set the distance between the tip end of the nozzle and the heating unit based on a measurement result of the temperature sensor.

According to the three-dimensional shaping device, the temperature of the plasticizing material stacked on the stage can be brought close to a desired value.

The three-dimensional shaping device according to the aspect may further include:
a position changing unit configured to change a relative position between the heating unit and the stage, in which
the stage may include a third heater,
when an (n−1)-th layer of the three-dimensional shaped object is shaped, the control unit may control, before shaping an n-th layer of the three-dimensional shaped object, the position changing unit to move the heating unit in a direction relatively away from the stage by a ninth distance, n being a natural number of 2 or more, and
when an (m−1)-th layer of the three-dimensional shaped object is shaped, the control unit may control, before shaping an m-th layer of the three-dimensional shaped object, the position changing unit to move the heating unit in a direction relatively away from the stage by a tenth distance smaller than the ninth distance, m being a natural number larger than n.

According to the three-dimensional shaping device, it is possible to reduce a difference, in a distance between the uppermost layer of the plasticizing material stacked on the stage and the heating unit, between the case of shaping the n-th layer and the case of shaping the m-th layer.

What is claimed is:

1. A three-dimensional shaping device, comprising:
a dispensing unit including a plasticizing unit that includes a first heater and plasticizes a material to generate a plasticizing material, and a nozzle that dispenses the plasticizing material;
a stage on which the plasticizing material is stacked;
a heating unit including a second heater that heats the plasticizing material stacked on the stage;
a drive unit configured to change a relative position between the nozzle and the heating unit; and
a control unit configured to control the drive unit, wherein
a tip end of the nozzle is positioned below the heating unit during shaping of a three-dimensional shaped object, and
the control unit controls the drive unit to set a distance between the tip end of the nozzle and the heating unit based on at least one of a temperature of the dispensing unit, a temperature of the heating unit, and a distance between the stage and the tip end of the nozzle.

2. The three-dimensional shaping device according to claim 1, wherein
the control unit sets the distance between the tip end of the nozzle and the heating unit to a first distance when setting a temperature of the first heater to a first temperature, and sets the distance between the tip end of the nozzle and the heating unit to a second distance smaller than the first distance when setting the temperature of the first heater to a second temperature higher than the first temperature.

3. The three-dimensional shaping device according to claim 1, wherein
the control unit sets the distance between the tip end of the nozzle and the heating unit to a third distance when setting a temperature of the second heater to a third temperature, and sets the distance between the tip end of the nozzle and the heating unit to a fourth distance larger than the third distance when setting the temperature of the second heater to a fourth temperature higher than the third temperature.

4. The three-dimensional shaping device according to claim 1, wherein
the stage includes a third heater, and
the control unit sets the distance between the tip end of the nozzle and the heating unit to a fifth distance when shaping an n-th layer of the three-dimensional shaped object, and sets the distance between the tip end of the nozzle and the heating unit to a sixth distance smaller than the fifth distance when shaping an m-th layer of the three-dimensional shaped object, n being a natural number, and m being a natural number larger than n.

5. The three-dimensional shaping device according to claim 4, further comprising:
a position changing unit configured to change a relative position between the heating unit and the stage, wherein
the dispensing unit is moved by the position changing unit according to movement of the heating unit,
when an (n−1)-th layer of the three-dimensional shaped object is shaped, the control unit controls, before shaping the n-th layer of the three-dimensional shaped object, the position changing unit to move the heating unit in a direction relatively away from the stage by a seventh distance, n being a natural number of 2 or more, and
when an (m−1)-th layer of the three-dimensional shaped object is shaped, the control unit controls, before shaping the m-th layer of the three-dimensional shaped object, the position changing unit to move the heating unit in a direction relatively away from the stage by an eighth distance smaller than the seventh distance.

6. The three-dimensional shaping device according to claim 1, further comprising:
a temperature sensor configured to measure temperature of the plasticizing material stacked on the stage, wherein
the control unit sets the distance between the tip end of the nozzle and the heating unit based on a measurement result of the temperature sensor.

7. The three-dimensional shaping device according to claim 1, further comprising:
a position changing unit configured to change a relative position between the heating unit and the stage, wherein
the stage includes a third heater,
when an (n−1)-th layer of the three-dimensional shaped object is shaped, the control unit controls, before shaping an n-th layer of the three-dimensional shaped object, the position changing unit to move the heating unit in a direction relatively away from the stage by a ninth distance, n being a natural number of 2 or more, and
when an (m−1)-th layer of the three-dimensional shaped object is shaped, the control unit controls, before shaping an m-th layer of the three-dimensional shaped object, the position changing unit to move the heating unit in a direction relatively away from the stage by a tenth distance smaller than the ninth distance, m being a natural number larger than n.
